(19) United States
(12) Patent Application Publication
(10) Pub. No.: US 2015/0001870 A1
(43) Pub. Date: Jan. 1, 2015

(54) Vehicle Computer System

(71) Applicant: Ironlight LLC, Lafayette, CO (US)

(72) Inventor: Daniel Walton Parcher, Broomfield, CO (US)

(73) Assignee: Ironlight LLC, Lafayette, CO (US)

(21) Appl. No.: 14/488,285

(22) Filed: Sep. 17, 2014

Related U.S. Application Data
(60) Provisional application No. 61/879,133, filed on Sep. 17, 2013.

(51) Int. Cl. B60R 11/02

(52) U.S. Cl. CPC B60R 11/0252; B60R 11/0258
USPC 296/1.07; 29/825

(57) ABSTRACT

The present invention relates to systems and methods for providing a dashboard computer system for a vehicle. Systems and methods are provided for installing a computer system in a vehicle dashboard. The dashboard or dashtop computer system includes components designed for installation of the system into the vehicle dashboard, such as a wiring harness for connection to the vehicle battery and/or audio speakers. Additionally, in certain embodiments, the dashtop computer system is configured for efficient and intuitive operation, such as by providing gesture-based commands to the computer system, and/or enabling the computer system to be disconnected from the vehicle battery and connected to an external device, such as a laptop computer, for software updates or data transfer. In an embodiment, the dashtop computer system utilizes a tablet computer, including a thin design, a touchscreen, and an internal battery.

### CROSS-REFERENCE TO RELATED APPLICATION

The present application claims priority to and the benefit of U.S. Provisional Application No. 61/879,133, filed Sep. 17, 2013.

### FIELD OF THE INVENTION

The present invention relates to systems and methods for providing a dashboard computer system for a vehicle.

### BACKGROUND OF THE INVENTION

Many automotive vehicles are equipped with stereo systems that are limited in capability, such as limited music options or outdated onboard navigation. Owners of these vehicles commonly replace the stereo system with an upgraded stereo system that provides additional features, such as updated navigation, a large graphic screen, or other options. However, even these upgraded stereo systems lack many desirable features, and can be difficult to install into an older vehicle.

Instead of relying on the in-dash stereo system, some vehicle owners utilize a mobile device such as a phone or tablet in the vehicle, such as by placing the mobile device in a receptacle mounted in front of or above the vehicle dashboard. Use of a mobile phone or other hand-held device in a vehicle is appealing, as it offers advantages such as a color screen, GPS (Global Positioning System) navigation, internet connectivity, and a hard drive for digital music files. However, these devices can be difficult to view or operate while driving, and the mounting receptacle—such as a removable suction cup—does not integrate the device into the vehicle dashboard. In addition, loosely mounted devices may be attractive to thieves if not removed when the occupant leaves the vehicle unattended. There remain many challenges to integrating such a device into a vehicle dashboard in way that is reliable, useful and visually appealing.

### SUMMARY OF THE INVENTION

The present invention relates to systems and methods for providing a dashboard computer system for a vehicle. In various embodiments, systems and methods are provided for installing a computer system in a vehicle dashboard. The dashboard or dashtop computer system includes components designed for installation of the system into the vehicle dashboard, such as a wiring harness for connection to the vehicle battery and/or audio speakers. Additionally, in certain embodiments, the dashtop computer system is configured for efficient and intuitive operation, such as by providing gesture-based commands to the computer system, and/or enabling the computer system to be disconnected from the vehicle battery and connected to an external device, such as a laptop computer, for software updates or data transfer. In an embodiment, the dashtop computer system utilizes a tablet computer, including a thin design, a touchscreen, and an internal battery.

In an embodiment, a kit is provided for retrofitting a computer system in a dashboard of an existing vehicle. The kit includes a computer having a touch screen, an internal battery, a power button, an audio output, and a power input. The kid also includes a wiring harness configured to connect the audio output from the computer to the audio speaker of the vehicle, and configured to connect the power input of the computer to the power source. The kit also includes a faceplate dimensioned to retain the computer to the vehicle, and having an opening for access to the power button of the computer through the faceplate. Optionally, the wiring harness includes an interruption along the wiring harness to disconnect the computer from the power source. The computer is configured to perform a function (such as advance an audio track, play an audio track, pause an audio track, adjust a volume, open an application, close an application, toggle between open applications, adjust a connectivity setting, adjust screen brightness, transmit a wireless signal, shut down the computer, restart the computer, and initiate a voice command) upon recognition of a gesture on the touch screen. The kit may include the computer itself, or the computer may be sold separately and simply connected to the vehicle via the kit's wiring harness.

In an embodiment, a method is provided for installing a computer system in a dashboard of a vehicle having a power supply and an audio speaker. The method includes mounting a tablet computer in an opening of the dashboard. The tablet computer includes a touch screen, an internal battery, a power button, and an input port. The method also includes providing power to the tablet computer from the vehicle power supply through the input port, connecting the tablet computer to the audio speaker, and retaining the tablet computer to the dashboard with a faceplate. The faceplate provides access to the power button of the tablet computer through the faceplate. The method also includes configuring the tablet computer to perform at least one of advance an audio track, play an audio track, pause an audio track, adjust a volume, open an application, close an application, toggle between open applications, adjust a connectivity setting, adjust screen brightness, transmit a wireless signal, shut down the computer, restart the computer, and initiate a voice command upon recognition of a gesture.

In an embodiment, a dashtop computer system for a vehicle includes a tablet computer electrically connected to the audio speaker of the vehicle, and a faceplate mounting the tablet computer to the dashboard of the vehicle. The faceplate includes a power button coupled to the tablet computer for turning the tablet computer on or off. The tablet computer includes a memory device storing computer-readable instructions for carrying out a designated function based on receipt of a designated gesture on the touch screen of the tablet and based on a state of the tablet computer.

### BRIEF DESCRIPTION OF THE DRAWINGS

FIG. 1 is a front perspective view of a vehicle dashboard including a dashboard computer system, according to embodiments of the invention.

FIG. 2 is an exploded perspective view of a dashboard computer system, according to embodiments of the invention.

FIGS. 3, 4, and 5 are front views of a dashboard computer screen, according to embodiments of the invention.

FIG. 6 is a schematic view of a dashboard computer system, according to embodiments of the invention.

FIG. 7 is a flowchart showing a method for retrofitting a computer system in a dashboard of a vehicle, according to embodiments of the invention.

FIG. 8 is a flowchart showing a method for navigating a vehicle, according to embodiments of the invention.

The figures depict embodiments of the present invention, for purposes of illustration only. One skilled in the art will readily recognize from the following discussion that alternative embodiments of the structures and methods illustrated herein may be employed without departing front the principles of the invention described herein.

### DETAILED DESCRIPTION OF THE INVENTION

The present invention relates to systems and methods for providing a dashboard computer system for a vehicle. In various embodiments, systems and methods are provided for installing a computer system in a vehicle dashboard. The dashboard or dashtop computer system includes components designed for installation of the system into the vehicle dashboard, such as a wiring harness for connection to the vehicle battery and/or audio speakers. Additionally, in certain embodiments, the dashtop computer system is configured for efficient and intuitive operation, such as by providing gesture-based commands to the computer system, and/or enabling the computer system to be disconnected from the vehicle battery and connected to an external device, such as a laptop computer, for software updates or data transfer. In an embodiment, the dashtop computer system utilizes a tablet computer, including a thin design, a touchscreen, and an internal battery.

Installation of a tablet computer into a vehicle dashboard presents many challenges—for example, connection of a separate computer to an existing electrical system, powering the computer at a suitable rate without damage, interacting with vehicle components such as microphones or speakers, providing access to the computer for hardware restart, connecting the computer to an external device for data transfer or software updates, and configuring the computer for intuitive and reliable operation by an occupant of the vehicle. The vehicle environment differs from other environments where a computer may commonly be used, such as hand-held use of a laptop computer or a tablet computer by an individual for browsing the web, reading entails, or taking or sharing photographs. The vehicle environment puts different demands on the computer. As discussed below, various embodiments are directed to implementing a computer such as a tablet computer in this challenging use case, and configuring the dashtop computer system for efficient and effective installation and use. Once configured and installed, the dashtop computer system can be used by the driver hands-free, in compliance with recent rules prohibiting driving while operating a hand-held mobile device.

Additionally, according to some embodiments, a kit is provided for retrofitting an existing vehicle with a dashtop computer system. An existing system, such as a radio, stereo, or navigation system, is removed horn the vehicle, and replaced with the dashtop computer system. In various embodiments, the newly installed dashtop computer system includes a tablet computer installed into the vehicle's dashboard. A kit is provided with components for installing the new computer system into the existing vehicle, and a method is also provided for the installation. The kit and method provide a standard process for incorporating the separate tablet computer into the dashboard of an older, existing vehicle, without relying on a custom installation job for each individual vehicle. While it is possible to install a tablet computer into an older vehicle by designing a custom installation tailored for that particular vehicle, embodiments of the invention address the need for a repeatable, standardized process for this type of installation. According to various embodiments, a method and associated kit for standard, repeatable installation of a dashtop computer system are provided.

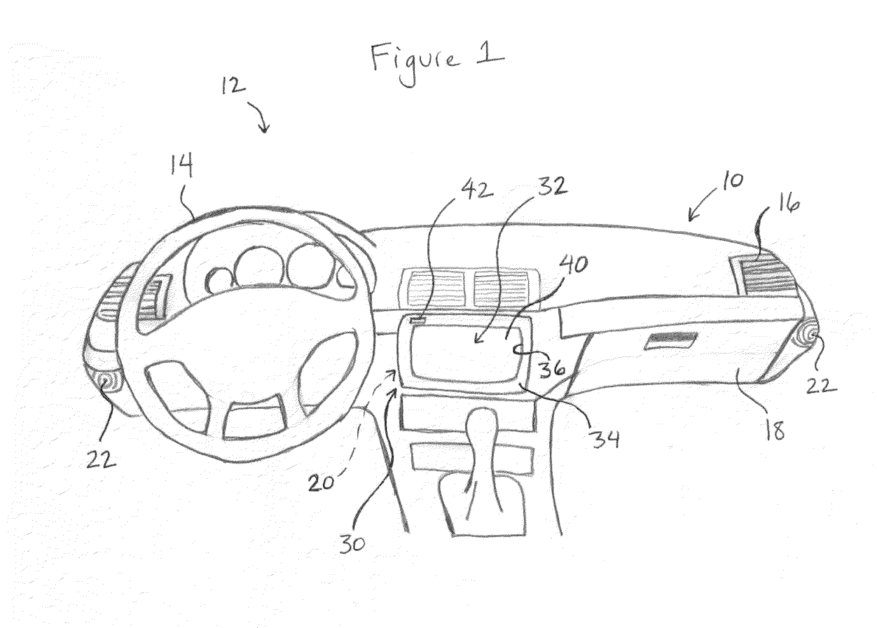

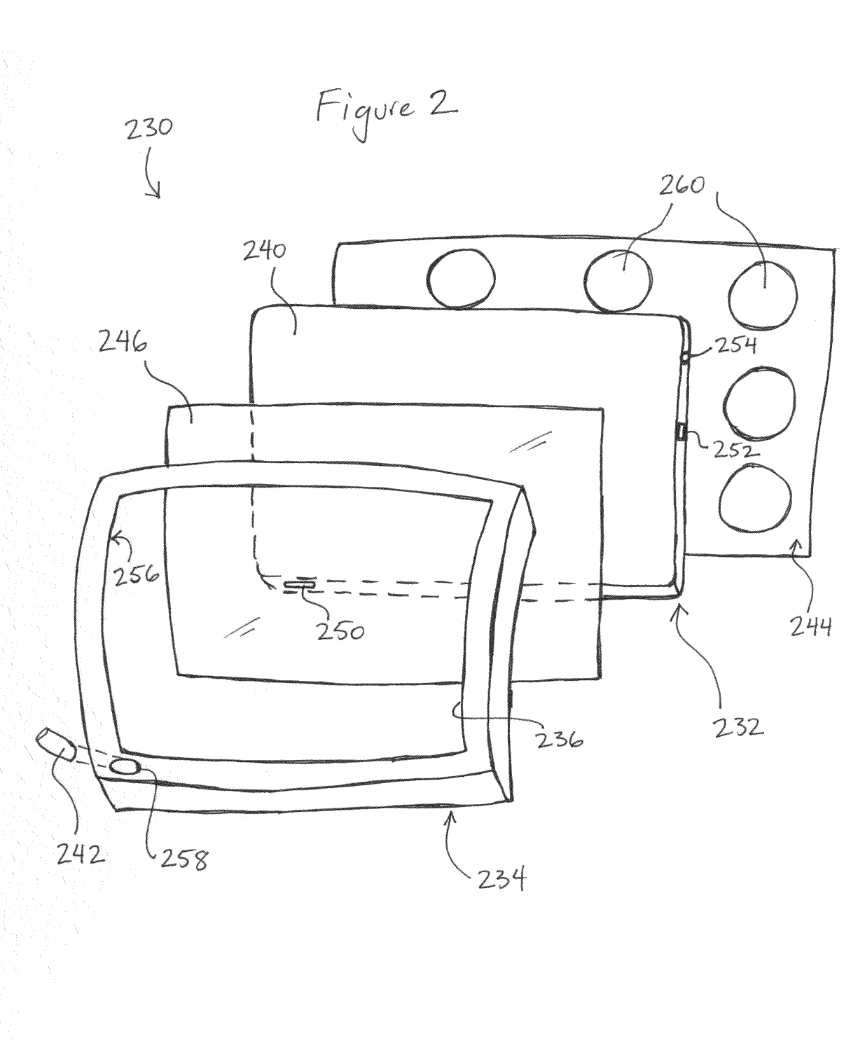

A perspective view of a dashboard 10 of a vehicle 12 is shown in FIG. 1. The dashboard includes existing automotive components common to many vehicles, such as a steering wheel 14, air vents 16, accessible interior compartment 18 (such as a glove compartment), and audio speakers 22. The dashboard 10 also includes a compartment or cavity 20 for a dashboard or dashtop computer system 30. The computer system 30 includes a tablet computer 32 mounted behind a faceplate 34. An example of a suitable tablet computer is the Nexus 7 from Google. The faceplate 34 is secured to the dashboard to retain the tablet computer in place. The faceplate 34 includes a window or opening 36 through which the tablet computer 32 is accessible. The tablet computer 32 includes a touchscreen 40 that is visible and accessible through the opening 30 of the faceplate 34. The faceplate 34 also includes a power button 42 that interfaces with the hardware power button on the tablet computer (described in more detail below with reference to FIG. 2). The power button 42 enables the user to manipulate the hardware power button on the tablet computer 32 without removing the tablet computer from the dashboard, removing the faceplate 34, or otherwise interfering with the tablet computer's installation into the dashboard 10.

An occupant of the vehicle 12 shown in FIG. 1 can operate the tablet computer 32 by interacting with the touchscreen 40 to control the tablet computer. For example, the user may use the tablet computer 32 to display maps or navigation instructions, play music programs over the vehicle's audio speakers 22, look up traffic information, record trip statistics, and/or run many other programs as described more fully below. The touchscreen 40 may utilize a capacitive sensor, which senses a change in capacitance based on the user's finger coming into proximity or into contact with the screen.

A perspective exploded view of a vehicle computer system 230 is shown in FIG. 2, The system 230 includes a front faceplate 234, a computer 232 (such as a tablet computer) with a screen 240, and a rear or backing plate 244. Optionally the system may also include a protective film or covering 246 that covers the computer screen 240. In an embodiment, the film 246 is a glare-reducing film that reduces reflection from the screen 240, such as the Ionic brand screen protective film (available on Amazon). This glare reduction can be particularly helpful to a driver to avoid interfering with the driver's vision. The film 346 can also protect the screen 240 from dirt and scratches, especially when the screen 240 is a touchscreen that is frequently contacted. In an embodiment, the film 246 also enables the driver to see the screen through polarized sunglasses—a common problem encountered by mobile device owners.

In an embodiment, the computer 232 is a tablet computer with a relatively large touchscreen 240, a thin profile, and no dedicated hardware keyboard. This type of computer is easy to view and operate when mounted in a vehicle, even when the user is not holding the computer in hand. The computer 232 may also include a hardware power button 250, data port 242, and audio port 254, as shown in FIG. 2. Other hardware buttons may also be included, though not necessarily shown in FIG. 2, such as volume up and volume down buttons. These hardware components are shown in FIG. 2 located along the thin edge of the tablet, but they may be located anywhere on the tablet as designed by the manufacturer. These hardware buttons and ports present one of the challenges of retrofitting a tablet computer into a vehicle, as they are not placed with vehicles in mind, and can be difficult to access from a dashboard.

In the embodiment of FIG. 2, the faceplate 234 is designed to retain the computer 232 to the vehicle dashboard. The faceplate 234 may include an interior lip 256 that sits against the front race of the computer 232 to securely hold the computer to the dashboard. A rear flange of the faceplate 234 may in turn be secured to the cavity of the dashboard. The faceplate 234 may be designed to match the vehicle's trim, such as by having a curved contour or other finishes, to provide a polished look. The faceplate 234 may be removable from the dashboard to provide access in the computer if needed.

In the embodiment of FIG. 2, the faceplate 234 includes an opening 258 for an actuator 242, such as a mechanical power button, that interlaces with the hardware power button 250 on the computer 232. The actuator 242 provides access to the computers power button 250 through the faceplate 234 without having to remove the faceplate, the computer, or other trim pieces. This access to the power button 250 is important in order to enable the user to turn the computer 232 or screen 240 on or off physically, rather than just through software interaction with the touchscreen 240, or to power down or restart the system as may be necessary after an unanticipated shut down, such as a software crash or a high temperature condition. Depending on the particular computer 232, the location of the power button 350 may vary (such as on a side edge, top or bottom edge, front face, or back face of the faceplate, or in the dashboard). The actuator 242 may be moved accordingly along the faceplate 234 to an appropriate location.

The actuator 242 may take any suitable form, such as a mechanical button that physically contacts the power button 250, a lever, a spring-biased rod, a servo with an electronic switch, or other actuators. The actuator 242 is accessible to the user on the front side of the faceplate, and upon actuation moves a physical component to press the power button 250 behind the faceplate. Alternatively, the actuator 242 may electrically connect to the power input, behind the computer's power button 250 (rather than physically manipulating the power button 250), such that the actuator electrically switches the computer on or off upon actuation. Thus, the user can operate the power button 250 through the faceplate even when the computer 232 is fully installed into the dashboard.

Referring again to FIG. 2, the system 230 includes a backing plate 244 that supports the computer 232 and holds it against the interior lip 250 of the faceplate 234. The backing plate 244 may be secured to the faceplate or to an interior component of the dashboard. The backing plate 244 includes cutouts or openings 260 to reduce the weight of the backing plate and to provide airflow to the computer 232 for cooling. A fan may be provided in the cavity 1 such as cavity 20 of FIG. 1) in order to increase airflow to the computer 232.

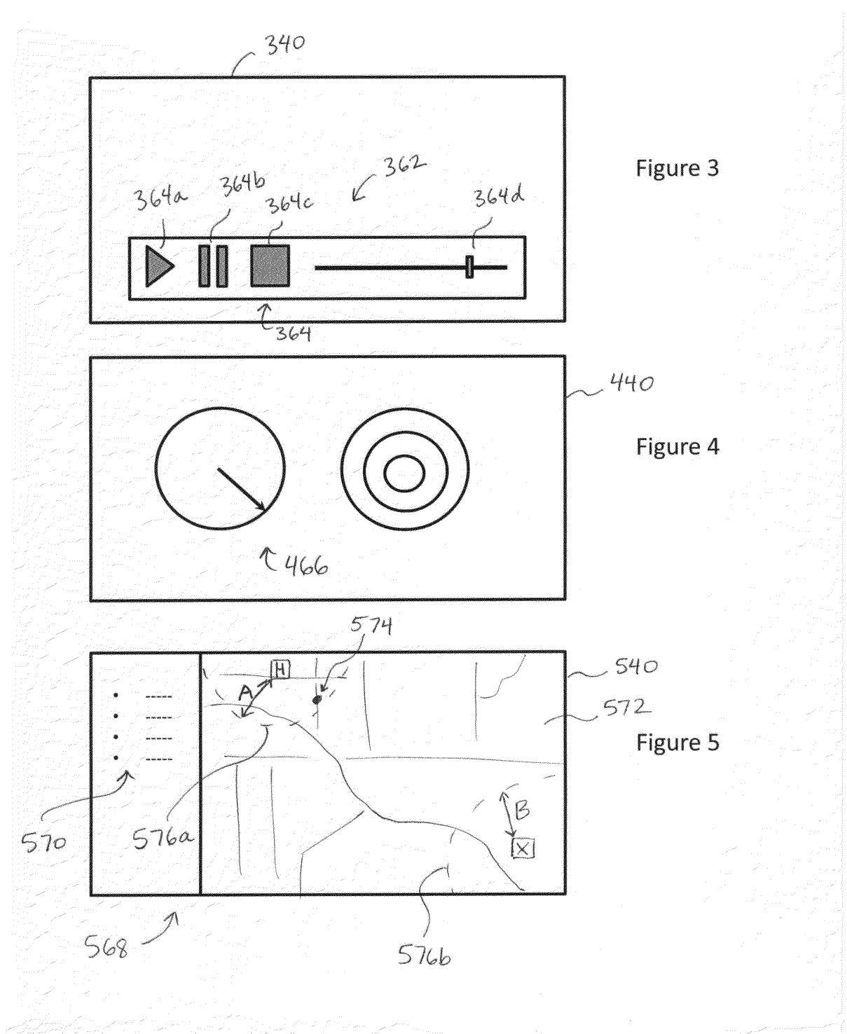

FIG. 3 shows a dashboard computer touchscreen 340, according to embodiments of the invention. It should be understood that the screen 340 is one screenshot of a dashboard computer that may be installed as shown in FIGS. 1 and 2. In FIG. 3, the computer is running an audio program 362, which has displayed audio controls 364, such as play 364a, pause 364b, stop 364c, and volume 364d. The controls 364 can be operated by physical contact with the touchscreen 340 at the location of each control. That is, the user can start the audio program by touching the play button 364a, for example to start playing music. In an embodiment, the dashtop computer is also configured to operate the controls 364 by gestures received on any portion of the screen 340.

A gesture is a recognized pattern or template of contact on the touchscreen. For example, gestures include double-tapping the screen, swiping a finger across the screen in a particular direction (including upward, downward, sideways, or diagonal), multi-finger (two, three, or more fingers) swiping, drawing a circle on the screen (clockwise or counter-clockwise), other swiping or contact patterns, and other ways of contacting the screen in a distinct, recognizable way. In some embodiments, these gestures are touch-based gestures, based on contact by the user on the touch screen. The computer recognizes each of these individual gestures, and each gesture may be tied to a particular operation by the computer. A gesture may also be tied to a particular state of the computer; thus, the same gesture may map to one function when, the computer is in one state, and another function when the computer is in another state. For example, double-tapping the screen may pause music if music is playing, and play music is music is paused. Swiping down with two fingers may switch the screen to a dimmer setting if the screen is bright, or to a brighter setting if the screen is dim. Thus, depending on a state of the computer, receipt of a particular gesture on the touchscreen causes a designated action. Different gestures can be mapped to different actions, and these mappings can vary depending on the state of the computer, and can be changed by the user.

Gesture-based control of the dashtop computer system provides an efficient way for the user to interact with the computer. Increasing volume can be a simple upward swipe, without requiring that the user look to the computer screen, identify the volume control 364d, and move the volume slider to the desired level. Similarly, pausing a music file can be as easy as double-tapping anywhere on the screen, which can be done easily without first looking at the screen to identify and contact a dedicated pause icon 364b.

In various embodiments, the dashtop computer system with, touchscreen 340 is configured to recognize gestures from the user, and to operate the audio program 362 in response to the gesture. A few examples are listed here. The computer may pause the audio track in response to a double-tap gesture, if the audio was playing at the time of the gesture, or play the audio track in response to a double-tap gesture, if the audio was not playing at the time of the gesture. The computer may increase or decrease the volume if the user swipes up or down.

Although gestures are described in detail with respect to the audio program shown in FIG. 3, it should be understood that the computer may be configured to take other actions, and operate other programs, based on gesture inputs. Gestures can be configured to initiate a voice command or search; for example, the user can swipe the screen with two fingers and then give voice commands to the computer. Gestures can also be configured to access or adjust configurations, settings, modes, or operation of the computer. For example, gestures can be configured to open an application such as a navigation program or a frequently used application, adjust a volume of the device, close an application, toggle between open applications, adjust a connectivity setting (such as, for example, turning on or off a wireless module), adjust screen brightness (such as, for example, reducing, the brightness for night driving), transmit a wireless signal (such as to a user's phone), shut down the computer, restart the computer, and initiate a voice command.

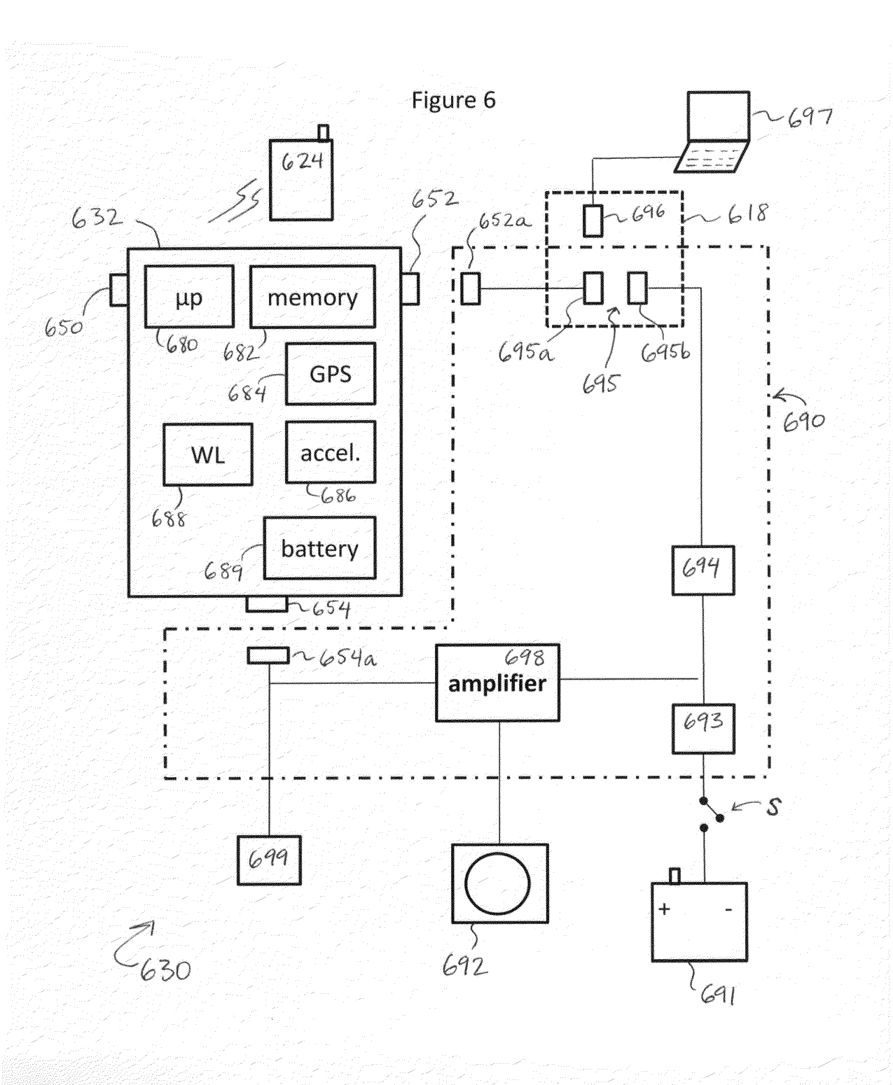

In some embodiments, the gestures are stored in non-transitory or non-volatile computer readable medium, such as a memory device, which stores computer-readable instructions or information for carrying out the designated functions trapped to each gesture. The computer includes a microprocessor and a memory device (shown in FIG. 6, as discussed below). The memory device may include random access memory, read-only memory, flash memory, solid state memory, optical storage, disc storage, and/or any suitable computer-readable media. The microprocessor is coupled to the memory device and is capable of reading the stored instructions. The computer-readable instructions may take the form of software applications, an operating system, or other computer-implemented functions.

FIG. 4 shows a dashboard computer touchscreen 440, according to embodiments of the invention. The dashboard computer with touchscreen 440 is shown, displaying real-time measurements from an internal accelerometer 466, which displays information about the movement of the computer. For example, the program 466 may utilize an accelerometer or compass in the computer to calculate and display information about the velocity, acceleration, or orientation of the vehicle in which the computer is installed. In an embodiment, the computer is configured to automatically display acceleration information, such as the display in FIG. 4, when the accelerometer detects acceleration of the vehicle above a threshold. For example, if the car is accelerating rapidly, the program shown in FIG. 4 automatically displays, so that the user can view the acceleration information. This is one example—in other embodiments, the computer may automatically initiate or display other applications upon other detected events or states of the computer or the vehicle.

FIG. 5 shows a dashboard computer touchscreen 540, according to embodiments of the invention. The dashboard computer with touchscreen 540 is shown operating a navigation program 568. In the example shown, the navigation program displays a list of directions 570, a map 572, a destination marked “X”, a home location marked “H”, and a current location 574. The computer may include a GPS (global positioning system) receiver that enables the program to identify the current location 574 of the vehicle. On-board or downloaded map information can then be used to display the map 572 and the directions 570. Audible navigation may also be provided to guide the driver through the directions to the destination X.

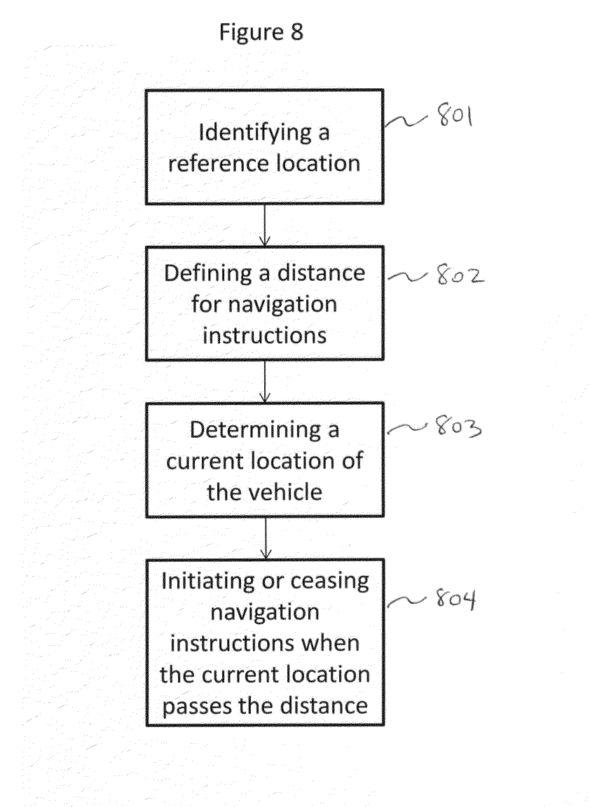

The touchscreen 540 may also display a distance marker 576a or 576b indicating a distance from a particular location. For example, distance marker 576a shows a distance A from home location H, and distance marker 576b shows a distance B from destination location X. These distance markers may be used in connection with a method for navigation which is described in further detail below with respect to FIG. 8.

FIG. 6 shows a schematic view of a dashboard computer system 630, according to embodiments of the invention. The dashboard computer system includes a computer 632, such as a tablet computer, which includes a power button 650, input port 652 (such as a data port), and audio port 654. The computer also includes internal components including a microprocessor 680, a memory 682, a GPS receiver 684, an accelerometer 686, a wireless module 688, and a battery 689. The input port 652 is a port that can receive power to charge the internal battery 689 of the tablet computer. This may be an AC or DC power port. The input port may have other functions as well; for example, it may be a data port that receives and transmits data from the tablet computer, as well as receiving power.

In some embodiments, the computer system 630 is electrically connected to a power supply (such as the vehicle's onboard battery) 691 and speaker system 692 via a wiring harness 690. In an embodiment, the wiring harness 690 includes the components shown within the dotted line 690. In particular, the wiring harness 690 provides wiring and connector 652a that electrically connect the input port 652 to the vehicle battery 691, to provide power to the computer 632 via the input port. In an embodiment, the input port 652 may be a mini-USB port or a micro-USB port that can transmit data and power to the computer 632. The wiring harness may include a voltage converter 693 that converts the voltage from the battery 691 to a lower value to the input port 652 of the computer. In one embodiment, the voltage converter 693 is a DC (direct current) step-down converter that converts the 12V output from the battery to a 5V input voltage for the computer 632. The converter 693 is located electrically between the vehicle battery 691 and the input port 652. FIG. 6 also shows the vehicle's ignition switch S between the wiring harness and the vehicle battery 691.

In an embodiment, the wiring harness electrically connects the computer 632 to a power source, such as the vehicle's battery 691. The vehicle battery is a convenient source of power, but another suitable power source or power supply may be used, such as a dedicated battery for the computer, or another battery onboard the vehicle. It should also be noted that in other embodiments, the wiring harness does not electrically connect the computer 632 to any separate power source, and instead the computer 632 relies on its own internal battery for power. This internal battery can be charged periodically by solar panels, inductive charging, swapping batteries, or other methods.

In the embodiment shown in FIG. 6, the input port 652 is used to charge the internal battery 689 of the computer 632. In other embodiments, other ports may be used to provide power, or the computer 632 may even be charged inductively or wirelessly. The computer 632 or wiring harness 690 may include a feature that limits the rate at which is draws power through the input port 652. Thus, when the input port 652 is used to charge the computer 632 from the vehicle battery 601, the wiring harness 690 may also include a data connection short circuit 694 located between the vehicle battery 601 and the input port 652. The data connection short circuit 694 connects the two data lines from the input port 652 to each other, creating a short of the data circuit, signaling to the tablet (either via hardware or software configuration) to increase current to the internal battery 689. As a result, the computer 632 can charge at a faster rate. The configuration of many current tablets reduces the current the tablet draws through the USB port unless the USB data cables are in a “shorted” configuration. The short circuit provides a low-resistance connection between the data wires, enabling the current to flow through the area of low resistance, bypassing the rest of the circuit.

In the embodiment of FIG. 6, the wiring harness 690 also includes an interruption in the connection between the input port 652 and the short circuit 694. In an embodiment, the interruption is an access point 695, with detachable connectors 695a and 695b. These connectors can be detached from each other, to disconnect the computer 632 from the vehicle battery 691. The computer 632 can then be connected to a separate, external device 697 (such as a laptop computer), by attaching the computer-side connector 695a to the external device via a suitable connector 696. This enables the computer 632 to be safely connected to an external device without electrically connecting the external device to the vehicle battery. For example, the external device 697 may be a laptop computer or a tablet computer, and the connectors 695a and 696 may be mating USB-type connectors. The external tablet, or laptop computer may be used to transfer software programs or data (such as music files) to the dashboard computer 632, or to download information from the dashboard computer 632. For example, trip information tracked by the dashboard computer (such as tracking information showing the vehicle's position over time, average speed, peak speed, and other information) may be downloaded from the dashboard computer onto the laptop computer. In another embodiment, the interruption may take the form of a user-operable switch. The user can flip the switch to connect or disconnect the computer to the vehicle battery.

Providing the user with the ability to disconnect the dashtop system from the vehicle-based power source and connect it to another device such as a laptop could be accomplished in a variety of other ways through alternative circuit configurations or user-accessible switches. In some embodiments, other limitations on providing power from the power source to the computer may be implemented. For example, the computer may include an internal sensor which prevents charging under certain temperature conditions. The wiring harness may also include one or more environmental sensors to prevent connecting the tablet to the power source under specific temperature or other environmental conditions.

In an embodiment, the interruption (such as access point 695 or switch) is located within an accessible interior compartment of the vehicle, such as the glove compartment 618. The user can easily access the connectors 695a, 695b when needed, and keep the connectors out of sight when not needed. In another embodiment, the interruption may be accessible through an opening in the faceplate or in the dashboard, similar to the opening 258 shown in FIG. 2 for the power button. The user may then operate the switch, or connect or disconnect the connectors, through the opening in the faceplate or dashboard.

As shown in FIG. 6, the wiring harness 690 also includes connector 654a that connects the audio port 654 of the computer to the vehicle speaker system 602, optionally through an amplifier 698. The wiring harness also connects the audio port 654 to a microphone 690 located within the passenger area of the vehicle, so that the computer can receive voice commands or inputs from the occupants.

As noted above, the dashboard computer 632 includes a wireless module 688, which may include a wireless transceiver for transmitting and receiving data wirelessly. This wireless module may be used to communicate wirelessly with a wireless device 624, such as a mobile phone, other computer (e.g., laptop or tablet computer), wireless microphone, or other wireless devices. The computer 632 may communicate wirelessly with the user's mobile phone, and may be configured to control phone calls to the user's phone, such as placing or answering calls. The computer 632 may be configured to answer a phone call upon receipt of a particular gesture on the touchscreen.

In some embodiments, the dashboard computer 632 is configured to take certain actions based on gesture inputs from the user (as described in more detail above), as well as based on system states. For example, when the vehicle ignition is turned on and power from the vehicle battery is supplied to the computer 632, the computer 632 may automatically illuminate the touchscreen. When the ignition is turned off and power from the vehicle battery is terminated, the computer 632 may automatically turn off the touchscreen (and may take other steps to conserve power, as discussed in further detail below). The computer may remain powered on and operating from its own internal battery 689 while the vehicle is turned off. Thus, because the computer has its own internal battery, it can continue to operate without power from the vehicle, which may be useful for operating programs on the computer when the vehicle is parked (such as playing music, updating software on the computer, or simply waiting for the next input from the user). The user may press the power button 650 (for example, via an actuator as described above) to dim the screen, leaving the computer 632 turned on, when the user leaves the vehicle. The computer may then turn on automatically when the vehicle is next started, or the user may again use the power button 650 to illuminate the screen.

In some embodiments, the dashboard computer system 630 enters a low power state upon disconnection of the power supply 691, and exits the low power state upon connection of the power supply 691. For example, when the power supply 691 is the vehicle battery the dashboard computer 632 detects the disconnection of the power from the vehicle battery when the vehicle ignition is turned off. The computer 632 remains powered on, but begins to draw power from its internal battery. In order to conserve battery life, the computer implements one or more steps to reduce the rate of power consumption of the computer while it is disconnected from the vehicle battery. For example, in an embodiment, the computer 632 automatically disables, hibernates, throttles, or otherwise reduces the power consumption of a hardware module, such as its wireless module GPS receiver, or screen. The computer may also automatically haft, pause, suspend, throttle, or otherwise reduce the power consumption of a software application, such as a music program or a navigation program. Thus, in an embodiment, when the computer detects a loss of charging power, the computer turns off its wireless module, halts audio programs, turns off the screen, turns off or pauses other applications, or any combination of these steps.

In some embodiments, when the power supply is reconnected, such as by turning the vehicle ignition on, the computer 632 is configured to exit the low power state. For example, in an embodiment, the computer automatically enables its wireless module, enables its GPS receiver, illuminates the screen, turns on other power-consuming applications or tasks, or any combination of these steps. As a result, the user does not need to manually turn these programs or features on or off in order to save power when the user is not in the vehicle.

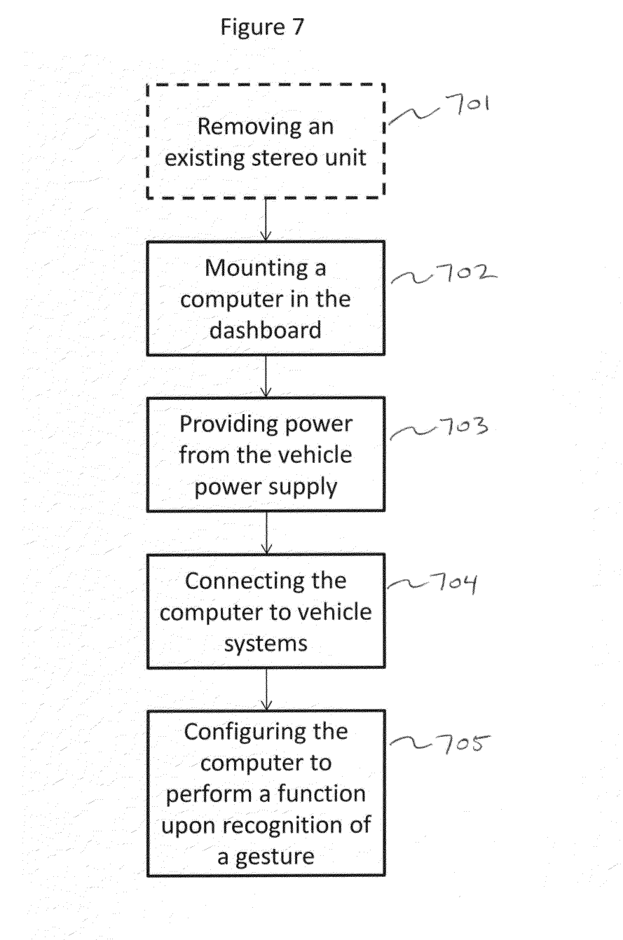

Turning to FIG. 7, a flowchart depicts a method for retrofitting a computer system in a dashboard of a vehicle, according to embodiments of the invention. The method includes, optionally, removing an existing stereo unit from the car 701. The method also includes mounting a computer into the dashboard 702. In an embodiment, this includes mounting a tablet computer in an opening of the dashboard. The tablet computer includes a touch screen, an internal battery, a power button, and an input port. Mounting the computer may include retaining the computer to the dashboard with a faceplate, with the faceplate providing access to the power button of the computer through the faceplate. The method also includes providing power to the computer from the vehicle power supply 703. This may include connecting the input port of the computer to the vehicle power supply, such as the vehicle battery. The method also includes connecting the computer to vehicle systems 704, such as connecting the computer to the audio speakers in the vehicle. The method also includes configuring the computer to perform a function upon recognition of a gesture 705. This may include, for example, configuring the computer to perform at least one of advance an audio track, play an audio track, pause an audio track, adjust a volume, open an application, close an application, toggle between open applications, adjust a connectivity setting, adjust screen brightness, transmit a wireless signal, shut down the computer, restart the computer, and initiate a voice command upon recognition of the gesture.

In an embodiment, a kit is provided for retrofitting a computer system in a dashboard of an existing vehicle. The kit includes a computer having a touch screen, an internal battery, a power button, an audio output, and a power input. The kid also includes a wiring harness configured to connect the audio output from the computer to the audio speaker of the vehicle, and configured to connect the power input of the computer to the power source. The kit also includes a faceplate dimensioned to retain the computer to the vehicle, and having an opening for access to the power button of the computer through the faceplate. Optionally, the wiring harness includes an interruption along the wiring harness to disconnect the computer from the power source. The computer is configured to perform a function (such as advance an audio track, play an audio track, pause an audio track, adjust a volume, open an application, close an application, toggle between open applications, adjust a connectivity setting, adjust screen brightness, transmit a wireless signal, shut down the computer, restart the computer, and initiate a voice command) upon recognition of a gesture on the touch screen. The kit may include the computer itself, or the computer may be sold separately and simply connected to the vehicle via the kit's wiring harness.

FIG. 8 is a flowchart showing a method for navigating a vehicle, according to embodiments of the invention. The method includes identifying a reference location 801, defining a distance for navigation instructions 802, determining a current location of the vehicle as it travels 803, and initiating or ceasing audible or visible navigation instructions 804 when the current location of the vehicle passes the defined distance. The reference location may be any desired location; examples include the home location H or the destination location X shown in FIG. 5. A distance for navigation instructions is defined, either by system defaults or by the user's input. For example, the user may specify that navigation should start when the user has traveled more than 10 miles from home H. In FIG. 3, the distance marker 576a indicates this distance on the map 572, for example, indicating a distance of 10 miles (or other defined distance) from the home location H (or other defined location). The computer system monitors the user's current location 574, and delays the navigation instructions until the user has traveled past this distance marker—that is, traveled more than the defined distance away from the reference location. This prevents the navigation program from providing instructions that the user does not need, due to the user's familiarity with the area.

The reference location may be a destination location, such as location X in FIG. 3. The distance marker 576b shows a defined distance from location X. The navigation program may delay the navigation instructions until the current location 574 of the vehicle passes the distance marker—that is, the user comes within the defined distance of the destination. Once the user's location comes within this defined area, audible and/or visible navigation instructions are initiated to guide the user to the destination. With this method, the user can avoid instructions that are not needed, and instructions will begin automatically when the user enters an area the user is not familiar with. This area may be defined either as a distance away from or toward a reference location. Navigation instructions drain battery power and interrupt music programs, so delaying them until they are needed can be beneficial.

In some embodiments, instead of delaying navigation instructions until the user passes the defined distance, the computer is configured to exit navigation instructions when the user passes the defined distance. Thus, for example, the user may request navigation instructions for the first 10 miles (or other defined distance) away from the home location H (or other defined location), or the user may request navigation instructions for the route until the user gets within 10 miles (or other defined distance) of the destination location X (or other defined location). The program provides audible and/or visible navigation instructions until the current location of the vehicle passes this defined distance, and then the navigation program automatically closes or quits. This feature allows the user to rely on navigation instructions for the first portion of a trip, but then automatically ceases these instructions when the user gets to a familiar area.

In some embodiments, installation of a dashboard computer system as described herein enables a wide range of functions and operations to be performed within the vehicle. The computer system may be configured to track trip statistics, for later download to a laptop computer for analysis or recordkeeping. If the dashboard computer is provided with an internet connection, it may transmit such information to another source in real-time during a trip, to allow another person to track where the vehicle is at ail times. The dashboard computer can be configured to accept phone calls, download music, play audio from internet radio stations, play videos, and many other functions that are typically not available on factory-installed, in-dash systems.

Although the present invention has been described through the use of exemplary embodiments. It will be appreciated by those of skill in the art that various modifications may be made to the described embodiments that fell within the scope and spirit of the invention as defined by the claims and their equivalents appended hereto.

What is claimed is:

1. A kit for retrofitting a stereo system in a vehicle having an audio speaker and a power source, comprising:
a computer having a touch screen, an internal battery, a power button, an audio output, and a power input;
a wiring harness configured to connect the audio output from the computer to the audio speaker of the vehicle, and configured to connect the power input of the computer to the power source;
a faceplate dimensioned to retain the computer to the vehicle, and comprising an opening for access to the power button of the computer through the faceplate;
wherein the wiring harness comprises an interruption along the wiring harness to disconnect the computer from the power source, and
wherein the computer is configured to perform a function upon recognition of a gesture on the touch screen, and wherein the function comprises at least one of advance an audio track, play an audio track, pause an audio track, adjust a volume, open an application, close an application, toggle between open applications, adjust a connectivity setting, adjust screen brightness, transmit a wireless signal, shut down the computer, restart the computer, and initiate a voice command.

2. The kit of claim 1, wherein the power source comprises a vehicle battery, and wherein the wiring harness further comprises a voltage converter between the access point and the vehicle battery, to reduce a voltage between the vehicle battery and the computer.

3. The kit of claim 1, further comprising a backing plate dimensioned to support the computer, the backing plate comprising an opening to allow a flow of air to reach the computer.

4. The kit of claim 1, wherein the computer is further configured to automatically illuminate the touch screen and enable an application or a hardware module when the vehicle is powered on, and to automatically dim the touch screen and disable the application when the vehicle is powered off.

5. The kit of claim 4, wherein the application comprises a global positioning system (GPS) application.

6. The kit of claim 1, wherein the interruption comprises a detachable connector, for disconnecting the computer from the power supply and for connecting the computer to an external device

7. The kit of claim 6, wherein the connector is positioned along the wiring harness to be located in an interior compartment of the vehicle.

8. The kit of claim 1, wherein the gesture comprises one of a double tap, an upward swipe, a downward swipe, and a single or multi-finger pattern swipe.

9. The kit of claim 1, wherein the power input of the computer comprises a data port and wherein the wiring harness comprises a short circuit of a data circuit between the access point and the power supply.

10. The kit of claim 1, wherein the function comprises pausing or playing an audio program, and wherein the gesture comprises a double tap gesture.

11. A method for installing a computer system in a dashboard of a vehicle having a power supply and an audio speaker, the method comprising:
mounting a tablet computer in an opening of the dashboard the tablet computer comprising a touch screen, an internal battery, a power button, and an input port;
connecting the tablet computer to the audio speaker;
retaining the table computer to the dashboard with a faceplate, the faceplate providing access to the power button of the tablet computer through the faceplate; and
configuring the tablet computer to perform at least one of advance an audio track, play an audio track, pause an audio track, adjust a volume, open an application, close an application, toggle between open applications, adjust a connectivity setting, adjust screen brightness, transmit a wireless signal, shut down the computer, restart the computer, and initiate a voice command upon recognition of a gesture.

12. The method of claim 11, further comprising providing power to the tablet computer from the vehicle power supply through the input port.

13. The method of claim 12, further comprising providing an interruption between the tablet computer and the vehicle power supply, for disconnecting the tablet computer from the power supply.

14. The method of claim 13, further comprising locating the interruption in an accessible interior compartment of the vehicle.

15. The method of claim 12, further comprising automatically dimming the touch screen, disabling an application, and maintaining a powered state of the tablet computer from the internal battery when the vehicle is powered off.

16. The method of claim 12, further comprising automatically illuminating the touch screen and enabling an application when the vehicle is powered on.

17. The method of claim 12, further comprising configuring the tablet computer to automatically halt an audio program when the vehicle is turned off.

18. The method of claim 11, further comprising providing navigation instructions to a destination, using the tablet computer.

19. The method of claim 18, further comprising initiating or exiting audible navigation instructions upon detection that the vehicle has passed a defined distance.

20. A dashtop computer system for a vehicle having an audio speaker and a dashboard, comprising:
a tablet computer electrically connected to the audio speaker of the vehicle, wherein the tablet computer comprises a touch screen; and
a faceplate mounting the tablet computer to the dashboard of the vehicle, wherein the faceplate comprises a power button coupled to the tablet computer for turning the tablet computer on or off, and
wherein the tablet computer comprises a memory device storing computer-readable instructions for carrying out a designated function based on receipt of a designated gesture on the touch screen and based on a state of the tablet computer.
